(19) United States
(12) Patent Application Publication
(10) Pub. No.: US 2013/0243366 A1
(43) Pub. Date: Sep. 19, 2013

(54) OPTICAL ELEMENT AND METHOD OF MANUFACTURE OF OPTICAL ELEMENT

(71) Applicant: FUJI ELECTRIC CO., LTD., Kawasaki-shi (JP)

(72) Inventor: Masanori OTO, Yokohama-city (JP)

(73) Assignee: FUJI ELECTRIC CO., LTD., Kawasaki-shi (JP)

(21) Appl. No.: 13/893,873

(22) Filed: May 14, 2013

Related U.S. Application Data
(63) Continuation of application No. PCT/JP2012/004184, filed on Jun. 28, 2012.

(30) Foreign Application Priority Data
Oct. 6, 2011 (JP) 2011-221858

(51) Int. Cl. G02B 6/26; G02B 6/27

(52) U.S. Cl. CPC G02B 6/262; G02B 6/2766
USPC 385/11; 385/50; 216/24

(57) ABSTRACT

A waveguide mounting portion (102) is formed at one portion of an optical fiber (100). The waveguide mounting portion (102) is formed by cutting away one portion of the optical fiber (100) in the direction of extension of the optical fiber (100) at a cross-section passing through a core (120) of the optical fiber (100). A first concave portion (122) is formed in the waveguide mounting portion (102). The first concave portion (122) is formed by removing the core (120) of the optical fiber (100). A ridge type waveguide (220) is inserted into the first concave portion (122).

### BACKGROUND OF THE INVENTION

1. Technical Field

This invention relates to an optical element in which an optical fiber and a waveguide are coupled to each other, and to a method of manufacture of an optical element.

2. Background Art

In recent years, techniques have been developed for wavelength conversion using quasi-phase matching. Quasi-phase matching is performed using an element in which a polarization inversion structure is formed periodically in a ferroelectric crystal. Quasi-phase matching is performed by, for example, imparting a polarization inversion structure to a waveguide. A waveguide having a quasi-phase matching function has, for example, a ridge type structure.

For example, Japanese Patent Application Laid-open No. 2003-140214 discloses the following method of manufacture of a waveguide. First, a ferroelectric crystal having a polarization inversion structure is directly joined to a substrate. Then, a groove is formed on the periphery of the portion of the ferroelectric crystal which is to become the waveguide. By this means, a ridge type waveguide is fabricated.

Japanese Patent Application Laid-open No. 2011-75604 discloses the following method of manufacture of a waveguide. First, a ferroelectric crystal having a polarization inversion structure is joined to a substrate using an adhesive layer. Then, a groove is formed on the periphery of the portion of the ferroelectric crystal, which is to become the waveguide. By this means, a ridge type waveguide is fabricated.

Light incident on the waveguide is guided to the waveguide using an optical fiber. Hence it is necessary to join the optical fiber and the waveguide. When joining an optical fiber and a waveguide, it is desirable that the task efficiency when determining the relative positions of the optical fiber and waveguide be high.

The present invention is directed to overcoming or at least reducing the effects of one or more of the problems set forth above.

### SUMMARY OF THE INVENTION

This invention was devised in the light of the above-mentioned circumstances. It provides an optical element and a method of manufacture of an optical element which enables easy determination of the relative positions of an optical fiber and a waveguide.

An optical element of this invention comprises an optical fiber and a ridge type waveguide having a convex-shaped cross-section. A waveguide mounting portion is formed in a portion of the optical fiber. The waveguide mounting portion is formed by cutting away a portion of the optical fiber in a direction of extension of the optical fiber at a cross-section passing through a core of the optical fiber. A first concave portion is formed in the waveguide mounting portion. The first concave portion is formed by removing the core of the optical fiber. The ridge portion of the waveguide is inserted into the first concave portion.

The following is a method of manufacture of an optical element of this invention. First, by cutting away an end face of an optical fiber in a direction of extension of the optical fiber at a cross-section passing through the core of the optical fiber, a waveguide mounting portion is formed. Next, by removing the exposed optical fiber core in the waveguide mounting portion, a concave portion is formed. Next, a ridge portion of a ridge type waveguide, having a convex-shaped cross-section, is inserted into the concave portion, and positioning between the optical fiber and the waveguide is performed.

By means of this invention, when joining an optical fiber and a waveguide, the relative positions of the optical fiber and waveguide can be determined easily.

### BRIEF DESCRIPTION OF THE DRAWINGS

The foregoing advantages and features of the invention will become apparent upon reference to the following detailed description and the accompanying drawings, of which:

The above-described object, as well as other objects, features and advantages will become clear from the preferred embodiments described below, and from the attached drawings.

FIG. 1 is a cross-sectional view showing the configuration of the optical element of a first embodiment;

FIG. 2 is a cross-sectional view showing the configuration of the optical element of the first embodiment;

FIG. 3 is a plane view of the optical element shown in FIG. 1 and FIG. 2;

FIGS. 4A to 4C show cross-sectional views of a first example of a method of manufacture of a waveguide member;

FIGS. 5(a) to 5(c) show cross-sectional views of a second example of a method of manufacture of a waveguide member;

FIGS. 6A and 6B explain a method of manufacture of the optical element shown in FIG. 1 to FIG. 3;

FIG. 7 explains a method of manufacture of the optical element shown in FIG. 1 to FIG. 3;

FIGS. 8A and 8B explain a method of manufacture of the optical element shown in FIG. 1 to FIG. 3;

FIGS. 9A and 9B explain a method of manufacture of the optical element shown in FIG. 1 to FIG. 3;

FIG. 10 explains a method of manufacture of the optical element shown in FIG. 1 to FIG. 3; and

FIG. 11 is a cross-sectional view showing the configuration of the optical element of a second embodiment.

### DETAILED DESCRIPTION OF SPECIFIC EMBODIMENTS

Below, embodiments of the invention are explained using the drawings. In all of the drawings, the same constituent elements are assigned the same symbols, and explanations are omitted as appropriate.

### First Embodiment

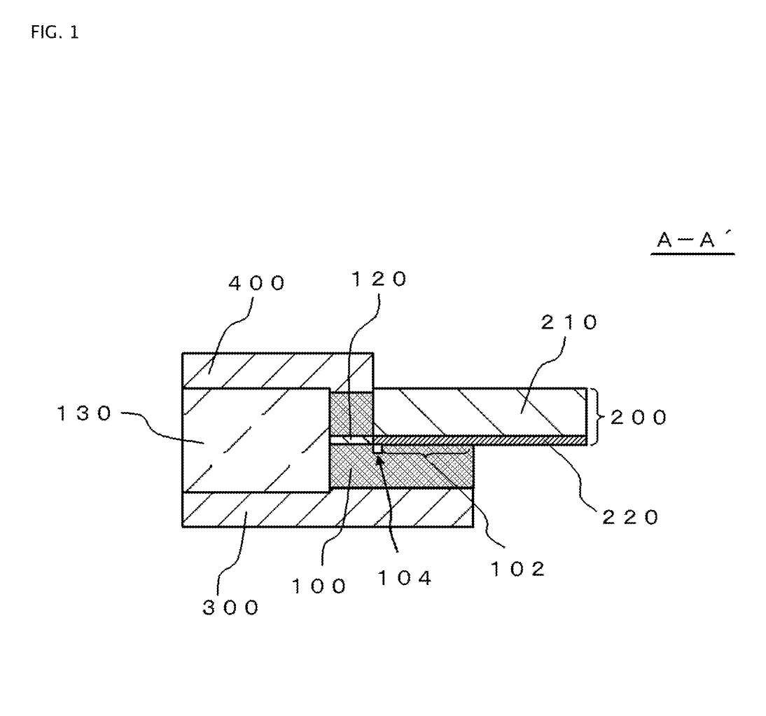

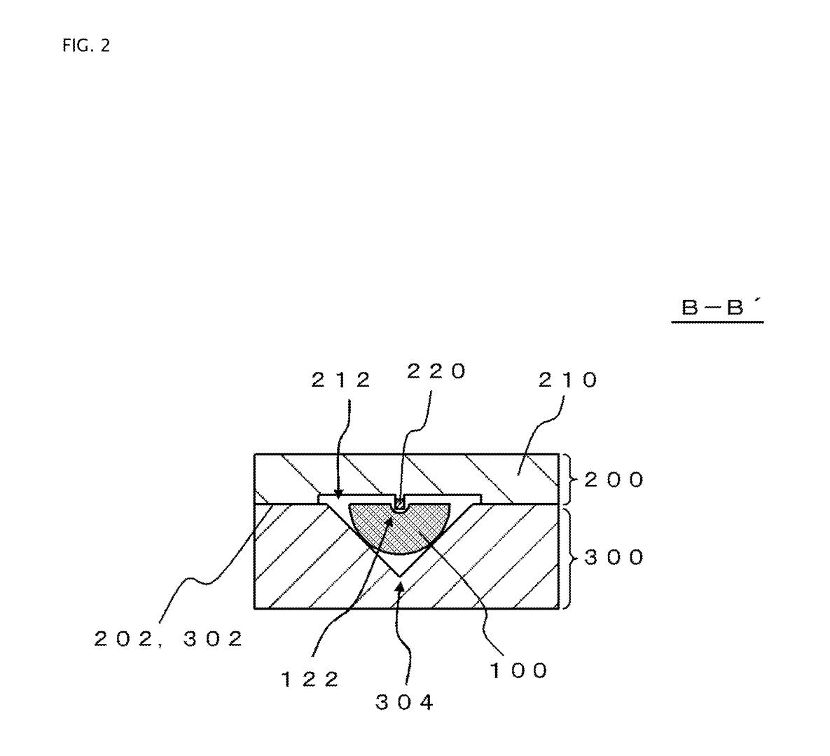

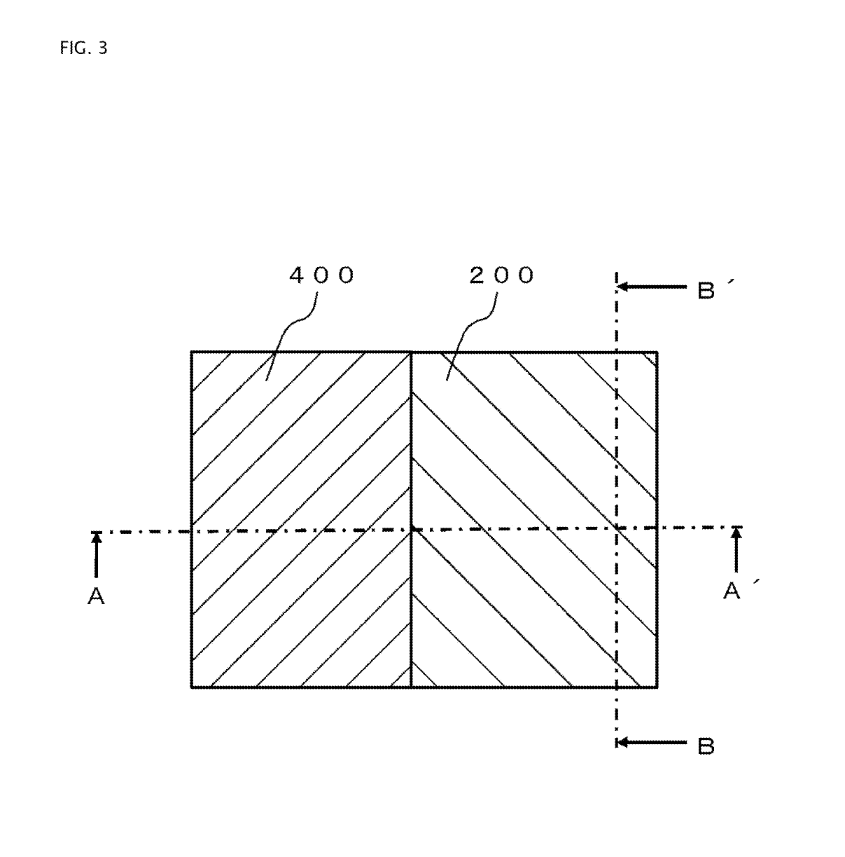

FIG. 1 and FIG. 2 are cross-sectional views showing the configuration of the optical element of a first embodiment. FIG. 3 is a plane view of the optical element shown in FIG. 1 and FIG. 2. FIG. 1 is a cross-sectional view at A-A′ in FIG. 3, and FIG. 2 is a cross-sectional view at B-B′ in FIG. 3.

This optical element comprises optical fiber 100 and ridge type waveguide 220. Waveguide mounting portion 102 is formed in one portion of optical fiber 100. Waveguide mounting portion 102 is formed by cutting away a portion of optical fiber 100 in the direction of extension (the right-left direction in the figure) of optical fiber 100 at a cross-section passing through core 120 of optical fiber 100. First concave portion 122 (FIG. 2) is formed in waveguide mounting portion 102. First concave portion 122 is formed by removing core 120 of optical fiber 100. As shown in FIG. 2, ridge type waveguide 220 is inserted into first concave portion 122. Waveguide 220 has a convex-shaped cross-section. Waveguide 220 is, for example, formed by stacking two layers with different refractive indices, and forming grooves on both sides of the guiding portion of one of the layers. In this optical element, optical fiber 100 causes light to be incident on waveguide 220 in some cases (incidence portion), and guides light emitted from waveguide 220 to the outside in some cases (emission portion). Below, the optical element is explained in detail.

As shown in FIG. 1 to FIG. 3, the end portion of optical fiber 100 is exposed from covering film 130. Waveguide mounting portion 102 is provided at this exposed portion. Specifically, waveguide mounting portion 102 is provided at the end portion of optical fiber 100. Waveguide mounting portion 102 is formed by cutting away the end portion of waveguide mounting portion 102 in the direction of extension of optical fiber 100 at a cross-section passing through core 120. On waveguide mounting portion 102, concave portion 104 is formed in the portion opposing the end portion of waveguide member 200. The role of concave portion 104 is explained when explaining a method of manufacture of the optical element.

Core 120 of optical fiber 100 has a refractive index different from that of the periphery due to the addition of an additive (for example, Ge). Because an additive is added to core 120, the etching selection ratio is different, under specific etching conditions, than for other portions of optical fiber 100.

Waveguide member 200 has a structure in which waveguide 220 is provided on ridge formation face 202 of substrate 210. The cross-sectional shape of ridge type waveguide 220 is, for example, square (rectangular), but may be semicircular or trapezoidal. Substrate 210 is formed from a material with a refractive index lower than that of waveguide 220, such as for example LiNbO₃ in a fixed ratio (stoichiometric composition). As shown in FIG. 2, the width of substrate 210 is wider than the diameter of optical fiber 100. Waveguide 220 is formed from a ferroelectric crystal. However, waveguide 220 may be formed from another material, such as quartz glass, silicon, or a compound semiconductor. The width of waveguide 220 is smaller than the diameter of core 120. On substrate 210, concave portions 212 are formed on both sides of waveguide 220. Concave portions 212 extend along waveguide 220. In plane view, the side faces of concave portions 212 on the sides opposite waveguide 220 are positioned further outside than optical fiber 100. Consequently, substrate 210 does not make contact with optical fiber 100.

The ferroelectric crystal forming waveguide 220 has a periodic polarization inversion structure. Consequently the optical element of this embodiment functions as a wavelength-converting device. The ferroelectric crystal forming waveguide 220 is, for example, LiNbO₃ with Mg added, but other materials may be used.

As shown in FIG. 2, optical fiber 100 and waveguide member 200 are mutually fixed by fixing member 300. Fixing member 300 has second concave portion 304 in fixing face 302, which holds the fiber. Second concave portion 304 is a groove, which is V-shaped in cross-section, and optical fiber 100 is inserted into second concave portion 304. The cross-sectional shape of second concave portion 304 is an isosceles triangle, such as, for example, a right isosceles triangle. However, the cross-sectional shape of second concave portion 304 is not limited to such shapes. Of fixing face 302, the portions positioned on both sides of second concave portion 304 are joined with ridge formation face 202 of substrate 210. Fixing member 300 is for example quartz glass, but a ceramic or resin may also be used.

Further, as shown in FIG. 1 and FIG. 3, the optical element comprises pressing member 400. Pressing member 400 together with fixing member 300 sandwiches and holds optical fiber 100. Pressing member 400 is formed from material similar to that of fixing member 300.

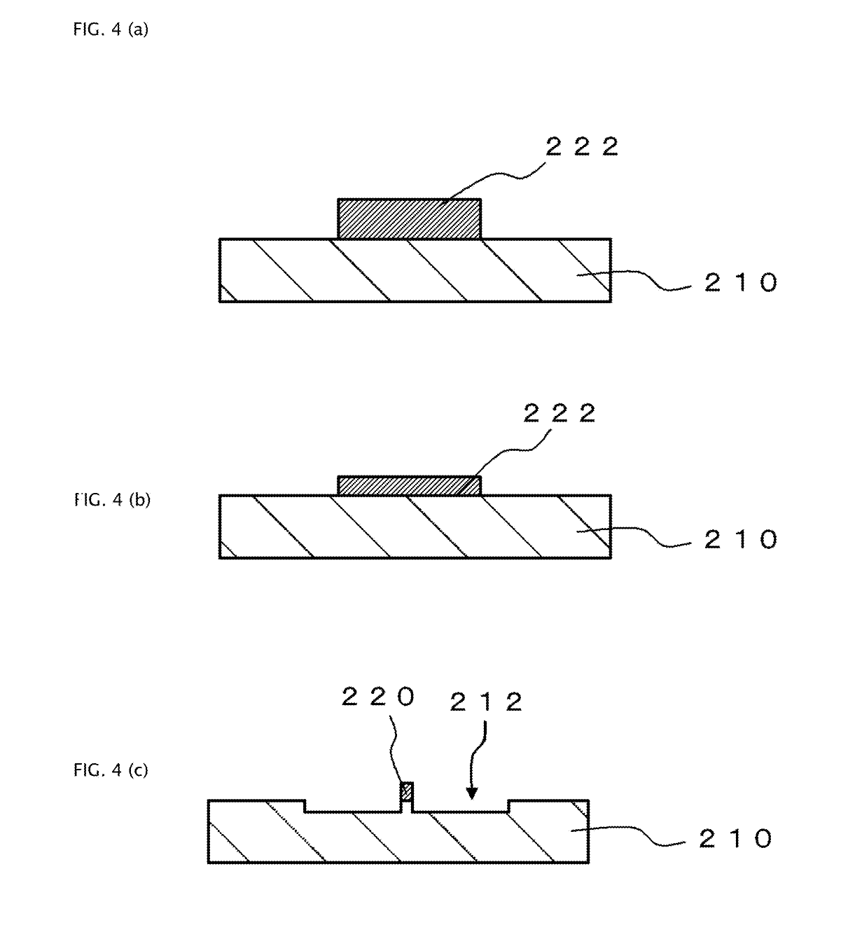

FIG. 4 shows cross-sectional views of a first example of a method of manufacture of waveguide member 200. First, a polarization inversion structure is formed in a ferroelectric crystal 222. Next, as shown in FIG. 4A, ferroelectric crystal 222 is fixed on substrate 210. This fixing method is, for example, direct joining. In this case, heating is applied in a state in which the ferroelectric crystal 222 is pressed against substrate 210. Substrate 210 and ferroelectric crystal 222 may also be fixed using an adhesive. In this case, after applying the adhesive to the face of ferroelectric crystal 222 which is to be joined to substrate 210, ferroelectric crystal 222 is pressed against substrate 210. In place of an adhesive, a low-melting point glass may be used.

Next, as shown in FIG. 4B, the thickness of ferroelectric crystal 222 is reduced to the required thickness. The method for reducing the thickness of ferroelectric crystal 222 may be mechanical polishing, or may be dry etching, or a method may be used in which ferroelectric crystal 222 is cut from a side face using a dicing saw. Faces of ferroelectric crystal 222 which are to be coupled with other optical members (for example, optical fiber 100) are mirror-polished.

Next, as shown in FIG. 4C, concave portions 212 are formed using a dicing saw and dry etching. By this means, waveguide 220 is formed.

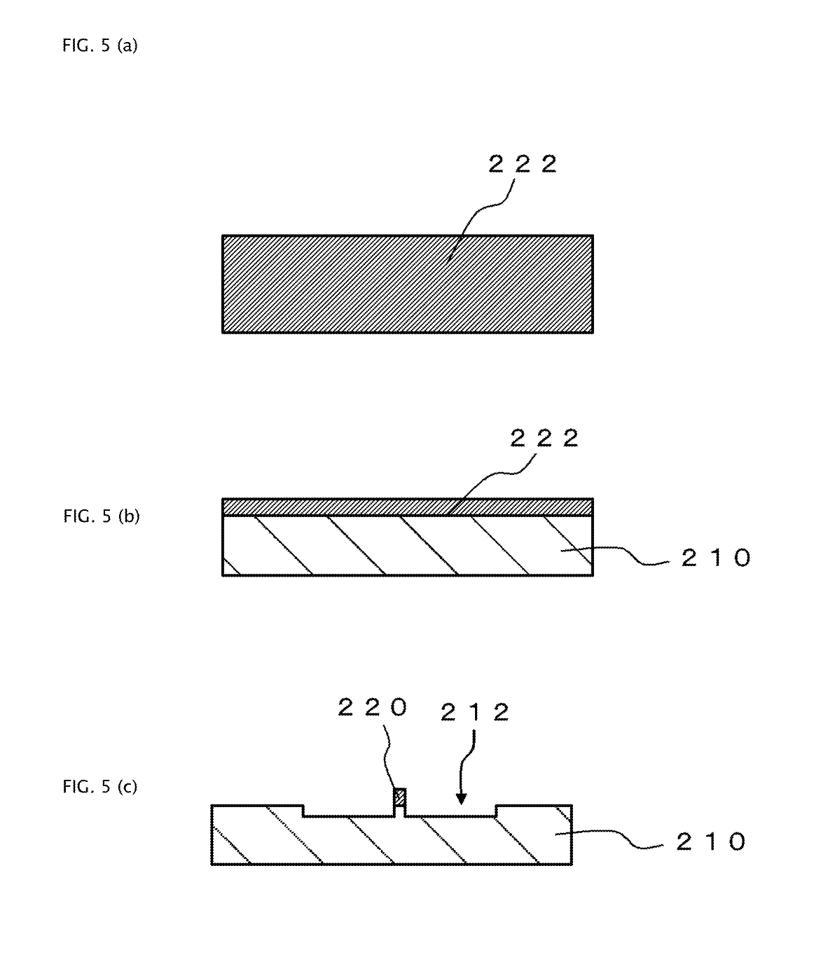

FIG. 5 shows cross-sectional views of a second example of a method of manufacture of waveguide member 200. First, as shown in FIG. 5A, ferroelectric crystal 222 is prepared. Then, a polarization inversion structure is formed in ferroelectric crystal 222.

Next, as shown in FIG. 5B, the refractive index is changed in a region of ferroelectric crystal 222 which is to become substrate 210. By this means, substrate 210 is formed. Substrate 210 is formed by, for example, subjecting ferroelectric crystal 222 to proton exchange treatment. Proton exchange treatment is performed by, for example, annealing ferroelectric crystal 222 in a state in which the face of ferroelectric crystal 222 which is to become substrate 210 is held in contact with benzoic acid or another acid.

Next, as shown in FIG. 5C, concave portions 212 are formed using a dicing saw and dry etching. By this means waveguide 220 is formed.

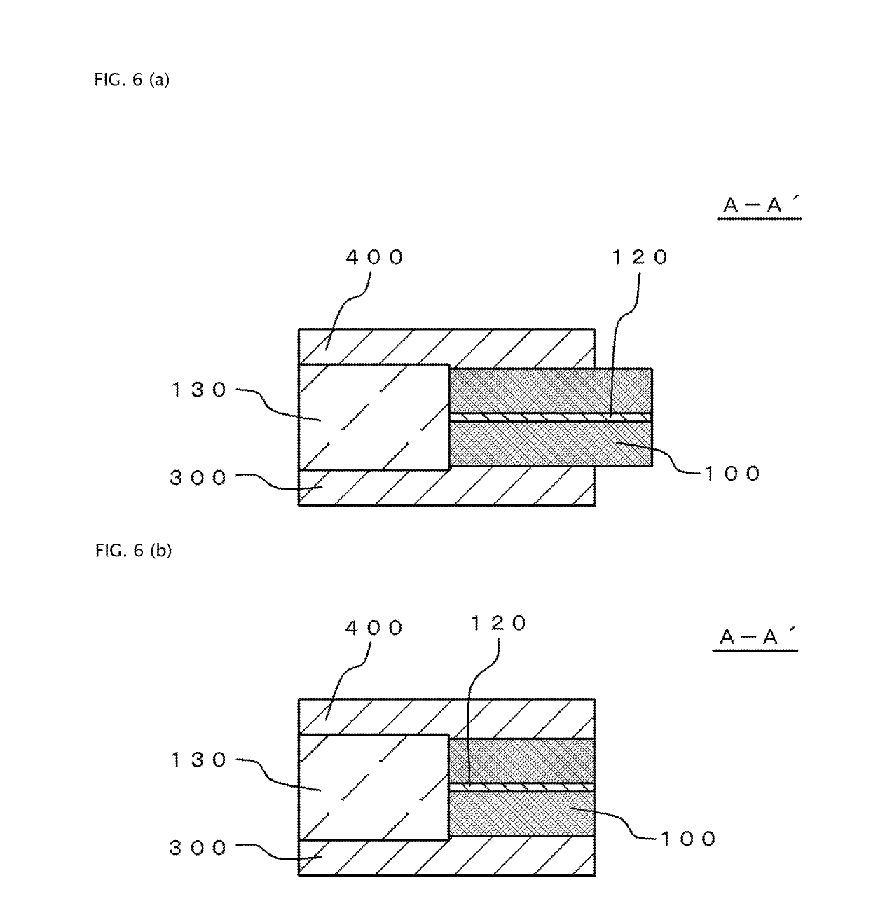

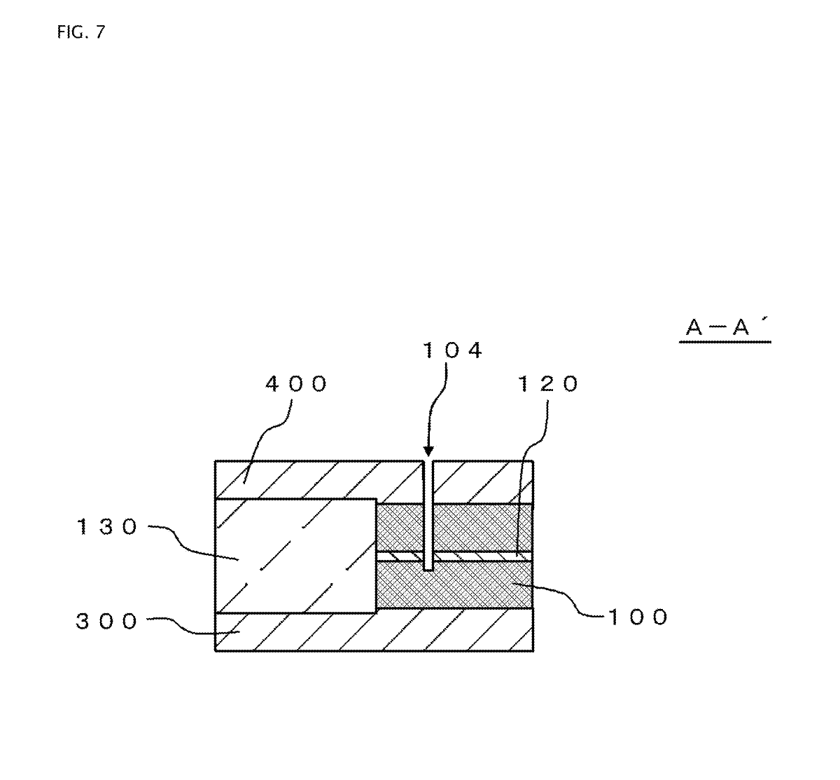

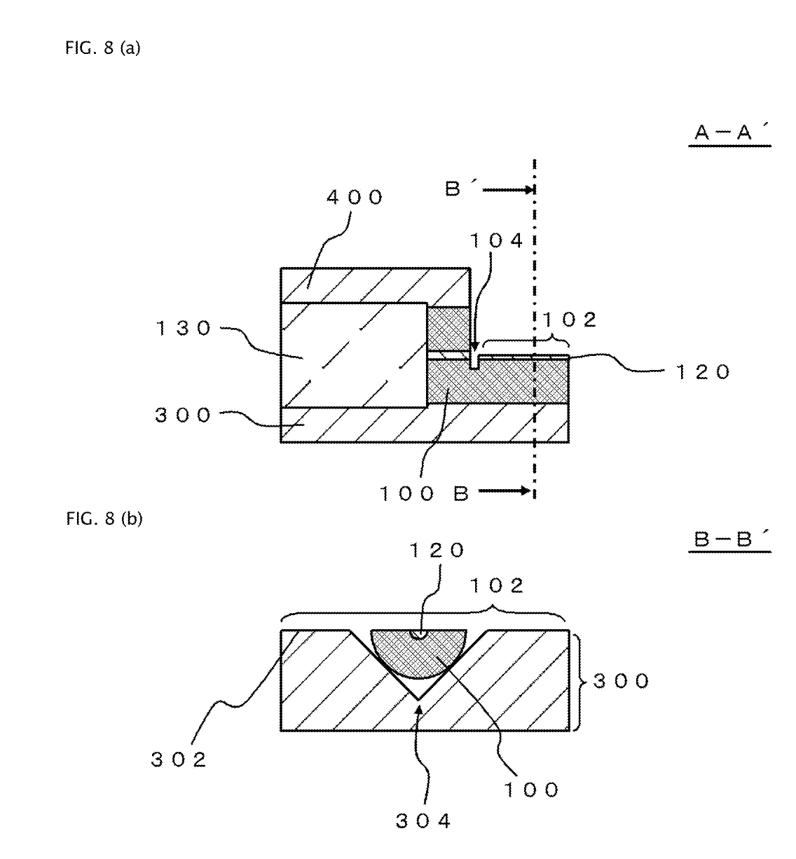

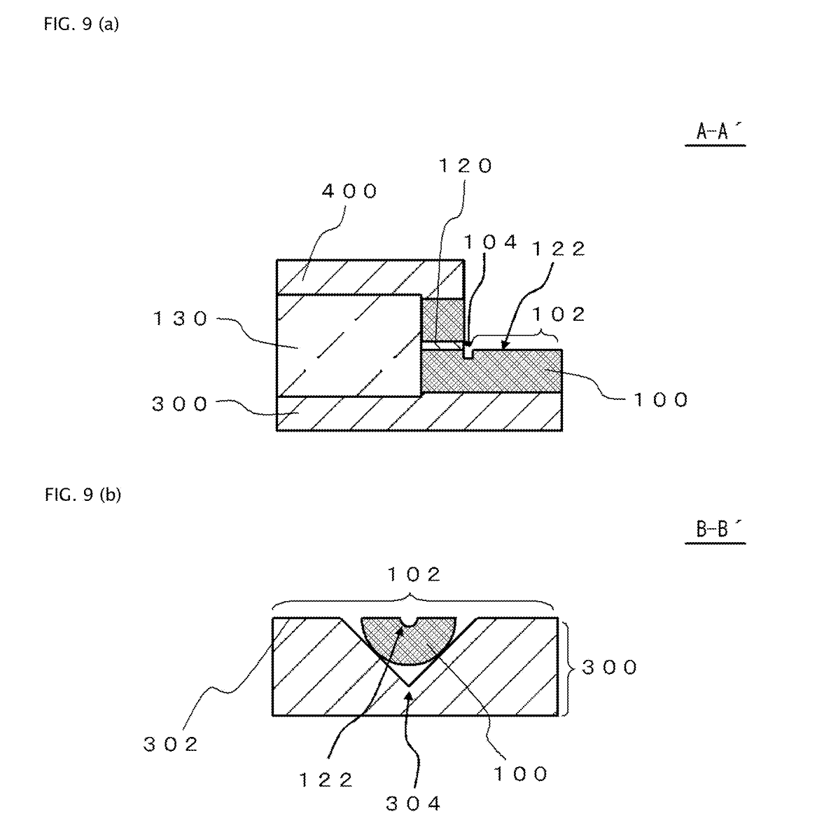

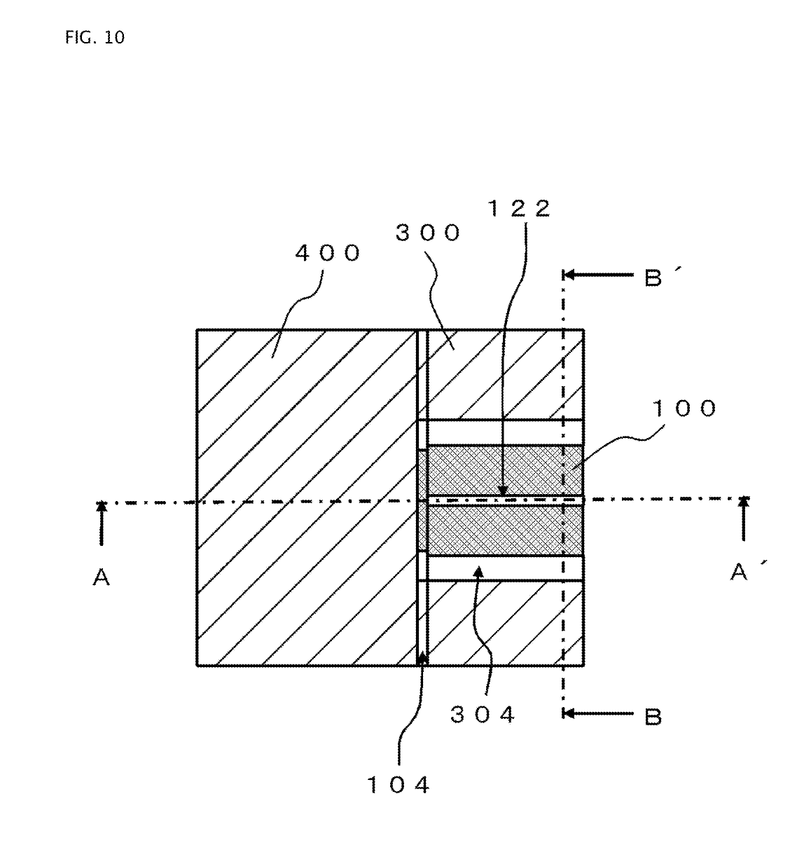

FIG. 6 to FIG. 10 explain a method of manufacture of the optical element shown in FIG. 1 to FIG. 3. Of these, FIG. 6A, FIG. 6B, FIG. 7, FIG. 8A, and FIG. 9A correspond to the cross-section at A-A′ in FIG. 3. FIG. 8B and FIG. 9B correspond to the cross-section at B-B′ in FIG. 3. FIG. 10 is a plane view of optical fiber 100, fixing member 300 and pressing member 400 shown in FIG. 9.

As shown in FIG. 6A, covering film 130 is removed from an end portion of optical fiber 100. The end portion of optical fiber 100 is inserted into second concave portion 304 (see FIG. 2) of fixing member 300, and then pressing member 400 is fixed against fixing member 300. By this means optical fiber 100 is fixed between fixing member 300 and pressing member 400. In this state, the end of optical fiber 100 protrudes from between fixing member 300 and pressing member 400.

Next, as shown in FIG. 6B, the portion of optical fiber 100 which protrudes from between fixing member 300 and pressing member 400 is removed by polishing or similar means. By this means, the end face of optical fiber 100, the end face of fixing member 300, and the end face of pressing member 400 are flush.

Next, as shown in FIG. 7, a dicing saw is introduced from pressing member 400 into optical fiber 100 in a direction perpendicular to the direction of extension of optical fiber 100. By this means, concave portion 104 is formed. The bottom portion of concave portion 104 is positioned within optical fiber 100 and lower than core 120. It is preferable that the abrasive of the dicing saw used to form concave portion 104 be sufficiently fine that the side faces of concave portion 104 are mirror surfaces.

Next, as shown in FIG. 8A and FIG. 8B, the portion positioned on the end portion side of concave portion 104 among the upper half of optical fiber 100 and pressing member 400 is removed by dicing and polishing. By this means, waveguide mounting portion 102 is formed. Waveguide mounting portion 102 has a planar shape. However, in this stage, a portion of core 120, for example approximately half, remains.

Next, as shown in FIG. 9A and FIG. 9B and in the plane view of FIG. 10, core 120 is removed by etching. By this means, first concave portion 122 is formed. The etching liquid used contains, for example, HF. However, core 120 may be removed by dry etching.

Thereafter, waveguide member 200 is placed on waveguide mounting portion 102. At this time, in a state in which waveguide 220 of waveguide member 200 is inserted into first concave portion 122, the angle of waveguide member 200 with respect to optical fiber 100 is adjusted, and the optical axes of waveguide 220 and optical fiber 100 are made to coincide. At this time, the end face of substrate 210 may be brought into contact with the face of optical fiber 100, which was a side face of concave portion 104. Then, ridge formation face 202 of substrate 210 and fixing face 302 of fixing member 300 are fixed using adhesive. In this way, the optical element shown in FIG. 1 to FIG. 3 is formed.

In the above embodiment, by removing the core 120 of optical fiber 100, first concave portion 122 is formed. And, by inserting waveguide 220 of waveguide member 200 into first concave portion 122, the relative positions of optical fiber 100 and waveguide member 200 are adjusted. Hence the relative positions of optical fiber 100 and waveguide 220 can easily be determined. When positioning waveguide 220, damage to ridge type waveguide 220 can be suppressed. Further, optical element manufacturing processes do not become complex.

Optical fiber 100 is inserted into second concave portion 304 formed in fixing face 302 of fixing member 300. Further, ridge formation face 202 of waveguide member 200 is fixed on fixing face 302 of fixing member 300. Hence after fabrication of the optical element of this embodiment, application of force to waveguide 220 of waveguide member 200 and damage to waveguide 220 can be suppressed.

### Second Embodiment

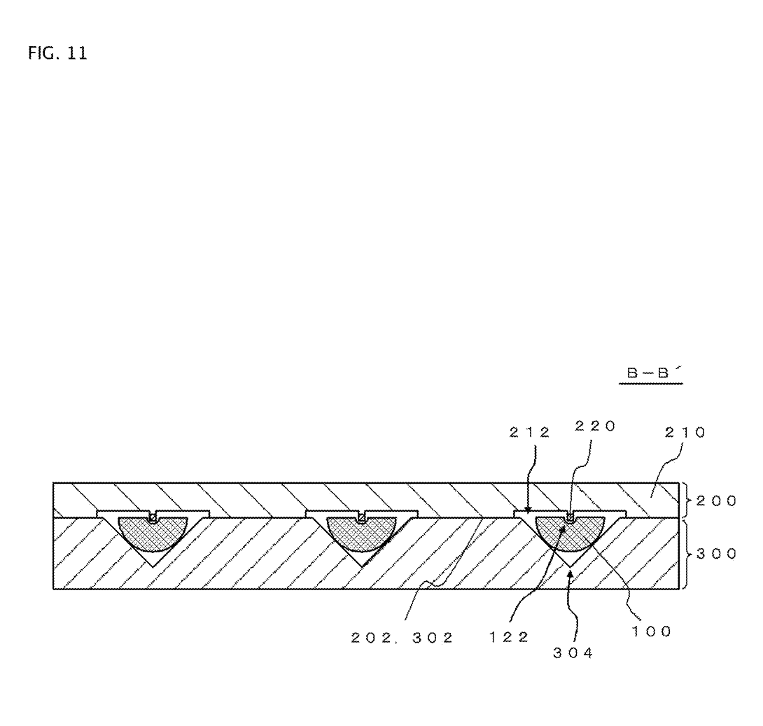

FIG. 11 is a cross-sectional view showing the optical element of a second embodiment, and corresponds to FIG. 2 (B-B′ cross-section) in the first embodiment. The optical element of this embodiment has a configuration in which a plurality of optical fibers 100 is connected to different waveguides 220.

The plurality of waveguides 220 is formed in one waveguide member 200. The structure and method of manufacture of each of waveguides 220 are as described in the first embodiment.

The plurality of optical fibers 100 are held by a single fixing member 300. In fixing face 302 of fixing member 300 are formed a plurality of second concave portions 304. Into each of the plurality of second concave portions 304 is inserted an optical fiber 100.

In this embodiment also, advantageous results similar to those of the first embodiment can be obtained. Further, optical fibers 100 and waveguides 220 can be configured in an array easily and inexpensively. Further, upon configuration in an array, damage to ridge type waveguides 220 can be suppressed.

### Example

Waveguide member 200 was fabricated using the method shown in FIG. 5. LiNbO₃ with Mg added was used in waveguide 220, and quartz glass was used in substrate 210. Concave portions 212 were formed by dicing. A polarization inversion structure was formed in waveguide 220. This polarization inversion structure was provided with a period to perform wavelength conversion by SHG (second harmonic generation) of infrared light (wavelength 1064 nm).

A single mode optical fiber was used as optical fiber 100. More specifically, as optical fiber 100, a polarization maintaining optical fiber with a cutoff wavelength of 980 nm was used. First concave portion 122 was formed by wetting optical fiber 100 for 15 minutes with a 10% HF aqueous solution.

Further, an ultraviolet light-hardening adhesive was used to fix waveguide member 200 and fixing member 300.

An optical element formed in this way satisfactorily performed wavelength conversion of infrared light by means of SHG. Hence this optical element demonstrated that use is possible as a wavelength conversion device for a laser light source device.

In the above, embodiments of the invention have been explained referring to the drawings, but the embodiments are merely examples of the invention, and various configurations other than the above can be adopted.

Thus, an optical element in which an optical fiber and a waveguide are coupled to each other, and a method of manufacture of an optical element have been described according to the present invention. Many modifications and variations may be made to the techniques and structures described and illustrated herein without departing from the spirit and scope of the invention. Accordingly, it should be understood that the methods and devices described herein are illustrative only and are not limiting upon the scope of the invention.

This application claims priority on the basis of Japanese Patent Application No. 2011-221858, filed on 6 Oct. 2011, the entire disclosure of which is herein incorporated by reference.

What is claimed is:

1. An optical element, comprising:
an optical fiber;
a waveguide mounting portion, in which a portion of the optical fiber in a direction of extension of the optical fiber at a cross-section passing through a core of the optical fiber is cut away;
a first concave portion, formed in the waveguide mounting portion and formed by removing the core; and
a ridge type waveguide, mounted on the waveguide mounting portion and having a convex-shaped cross-section,
wherein a ridge portion of the waveguide is inserted into the first concave portion.

2. The optical element according to claim 1, wherein the waveguide mounting portion is provided at an end portion of the optical fiber.

3. The optical element according to claim 2, wherein the waveguide mounting portion is provided at an end portion of the optical fiber.

4. The optical element according to claim 1, further comprising a fixing member which fixes the optical fiber and the waveguide.

5. The optical element according to claim 4, wherein
the waveguide is provided on a substrate,
a width of the substrate is greater than a diameter of the optical fiber in plane view, and
the fixing member includes a fixing face which is fixed to a face of the substrate in which the waveguide is formed, and a second concave portion provided in the fixing face and into which the optical fiber is inserted.

6. The optical element according to claim 5, wherein the waveguide is directly joined to the substrate.

7. The optical element according to claim 5, wherein the waveguide is joined to the substrate using an adhesive layer.

8. The optical element according to claim 5, wherein the waveguide and substrate are formed using a single base material, and one of the waveguide and the substrate is formed by changing a refractive index of the base material.

9. The optical element according to claim 1, wherein the waveguide is formed from a ferroelectric crystal, and the ferroelectric crystal has a polarization inversion structure.

10. The optical element according to claim 2, wherein the waveguide is formed from a ferroelectric crystal, and the ferroelectric crystal has a polarization inversion structure.

11. The optical element according to claim 3, wherein the waveguide is formed from a ferroelectric crystal, and the ferroelectric crystal has a polarization inversion structure.

12. The optical element according to claim 4, wherein the waveguide is formed from a ferroelectric crystal, and the ferroelectric crystal has a polarization inversion structure.

13. The optical element according to claim 5, wherein the waveguide is formed from a ferroelectric crystal, and the ferroelectric crystal has a polarization inversion structure.

14. The optical element according to claim 6, wherein the waveguide is formed from a ferroelectric crystal, and the ferroelectric crystal has a polarization inversion structure.

15. The optical element according to claim 7, wherein the waveguide is formed from a ferroelectric crystal, and the ferroelectric crystal has a polarization inversion structure.

16. The optical element according to claim 8, wherein the waveguide is formed from a ferroelectric crystal, and the ferroelectric crystal has a polarization inversion structure.

17. A method of manufacture of an optical element, comprising the steps of:
forming a waveguide mounting portion by cutting away an end face of an optical fiber in a direction of extension of the optical fiber at a cross-section passing through a core of the optical fiber;
forming a concave portion by removing the core exposed at the waveguide mounting portion; and
inserting a ridge portion of a ridge type waveguide having a convex-shaped cross-section, into the concave portion, and performing positioning of the optical fiber and the waveguide.

18. The method of manufacture of an optical element according to claim 17, wherein the core is removed by etching.
